(19) United States
(12) Patent Application Publication
(10) Pub. No.: US 2005/0128991 A1
(43) Pub. Date: Jun. 16, 2005

(54) Coordination between simultaneously operating Pico-Nets in high mobility wireless networks

(76) Inventors: Sriram Dayanandan, San Jose, CA (US); Francis DaCosta, San Jose, CA (US)

Correspondence Address: FRANCIS DACOSTA;C/O MESH DYNAMICS, SUITE 400, 2953 BUNKER HILL LANE, SANTA CLARA, CA, 95054, US

(21) Appl. No.: 11/036,297

(22) Filed: Jan. 7, 2005

Related U.S. Application Data
(63) Continuation-in-part of application No. 10/434,948, filed on May 8, 2003.
(60) Provisional application No. 60/535,668, filed on Jan. 9, 2004.

(51) Int. Cl. H04Q 7/24

(52) U.S. Cl. 370/338

(57) ABSTRACT

An embodiment of the present invention addresses Beacon Synchronization issues related to multiple Simultaneously operating Pico-Nets that could be potentially interfering with each other's transmissions. Algorithms and support functions are described that determine the optimal staggering of Beacons in the Contention Access Period (CAP) of an IEEE 802.15.X Pico-Net, where 802.15.X denotes both 802.15.3 and 802.15.4 application sets. The objectives of this invention are related to both types of networks. The approach described is stable, scalable and efficient. It is comprehensive, in that it addresses all typical use cases for how Devices and Pico Net Controllers would need to coordinate beacon information to ensure trouble free operation.

### CROSS-REFERENCE

This application is a Continuation-In-Part of U.S. Utility patent application Ser. No. 10/434,948, filed May 8, 2003, and entitled “High Performance Wireless Networks Using Distributed Control”. This application also claims benefit of U.S. Provisional Application No. 60/535,668, filed Jan. 9, 2004, and entitled “Coordination between simultaneously operating Pico-Nets in IEEE 802.15.03 wireless networks”, commonly assigned with the present invention and incorporated herein by reference.

This application is an extension to the embodiment of an ad-hoc wireless mesh algorithm, disclosed in Appendix B in patent application Ser. No. 10/434,948, filed May 8, 2003.

### FIELD OF THE INVENTION

This application addresses issues related to wireless networks, and in particular to coordination issues when there are multiple Pico-Net Controllers (PNCs) and multiple Pico-Net networks are located in the same area, and can interfere with each other's radio signals.

### BACKGROUND OF THE INVENTION

In the referenced patent application, Appendix B describes in detail a method to address Multi-zone support for Pico-Nets under control of a PicoNet Controller or PNC where a PNC is defined consistent with IEEE DRAFT P802.15.3/D16 dated February 2003. In this application, FIG. 1 depicts a configuration with two Pico-Nets. The devices marked as PNC are Pico-Net Controllers and devices marked as DEV belong to one or the other PNC. Radio is a shared medium. Devices under each Pico-Net shared a Collision Sense Multiple Access (CSMA) with Collision Avoidance (CA) Protocol, commonly referred to as CSMA/CA, to ensure that only one device is transmitting at any point in time. This avoids interference caused by simultaneous transmissions by multiple devices.

While devices in the same sub network or Pico-Net share a protocol regarding transmission scheduling, no such protocol exists across Pico-Nets. This can cause interference resulting from simultaneous transmissions occurring between devices sharing the same radio air space but in different Pico-Nets.

Additionally, in the case of Pico-Nets sharing the same channel, problems arise when the Beacon Synchronization Pulse sent by the Pico-Net Controllers, is not clearly received by the devices in the Pico-Net.

As an example, consider FIG. 2 showing the pattern of transmissions for two the Pico Net controllers in a wireless Personal Area Network (WPAN) shown in FIG. 1. The time slot marked B refers to the Beacon that the PNC sends out as a synchronization pulse for devices connected to it. A device connected to the Pico-Net must receive that beacon. If that beacon is missed by a device because of radio interference from other devices in other Pico-Nets, that device does not connect to the network while it has lost the synchronization pulse.

Accordingly, there exists a need for coordination between Pico-Net Controllers (PNC) and their devices to ensure that beacons are sent at times where there is no interference from near by radios that include both devices and other PNCs.

### SUMMARY OF THE INVENTION

802.15.X Mode of Operation:

One embodiment of this invention is to address the coordination and scheduling issues of sending Beacon in a multiple Pico-Net setting of IEEE 802.15.X networks. 802.15.X denotes both 802.15.3 and 802.15.4 application sets—the objectives of this invention are related to both types of networks. The algorithms and approach are also applicable to other types of wireless networks, notably low power wireless sensor networks (802.15.4). The invention is also relevant other networks such as the 802.16.X networks that use a similar Media Access Control (MAC).

Referring to FIG. 2, IEEE 802.15.X specifies a Contention Access Period (CAP) wherein nodes use CSMA/CA for packet transmission. The standard specifies two inter-frame spacing (IFS) for the CAP, BIFS (Backoff IFS) and SIFS (Short IFS).

On start up, device in the 802.15.X network listen for beacons. If it does not find any, it switches to a PNC mode of operation and starts sending out beacons. If a device after becoming a PNC hears beacons from another PNC, then the node that became a PNC later would revert to a DEV mode of operation. Nodes continue to send heartbeats. The heartbeats are sent during the CAP. In addition to the usual heartbeat information as described in the embodiment of the ad-hoc mesh invention, disclosed in U.S. patent application Ser. No. 10/434,948, the 802.15.X compliant implementation includes information about all PNCs that a DEV can hear.

Problems occur when two PNC are sending Beacons at the same time. In FIG. 1, Nodes 5 and 2 hear only one PNC (node 1), whereas Node 4 and 3 hear two (node 1, node 7). The problem here is that if the beacons are not synchronized, the devices that hear more than one Pico-net would face interference. There needs to be a method for synchronizing beacons sent by the Pico-Net controllers.

### BRIEF DESCRIPTION OF DRAWINGS

In order to more fully describe embodiments of the present invention, reference is made to the accompanying drawings. These drawings are not to be considered limitations in the scope of the invention, but are merely illustrative.

FIG. 1, illustrates a typical multi Pico-Net with two Pico-Net Controllers labeled PNC. Also shown are a number of devices connected to these Pico-Net Controllers and are marked as DEV. Additionally each node in the network has a node, the number on its upper right hand corner. The two PNCs, for example are Nodes 1 and 7.

FIG. 2 illustrates the IEEE 802.15.3 Interface protocol for devices in a 802.15.3 network. B refers to the Beacon Synchronization; CAP the Contention Access Period and CTA the channel time allocation period. The terminology is consistent with IEEE 802.15.3 specifications described in IEEE DRAFT P802.15.3/D16 dated February 2003.

FIG. 3 shows a shift in the Beacon Synchronization pulse for Node 7 which ensures that Nodes 7 and I are not interfering with each other's beacons. It also shows that the overlap in the CTA and CAP between Nodes 1 and 7 require that two CTA slots of node 1 be not be allocated. These two slots are marked as X in the figure.

FIG. 4 indicates how by aligning the CTA time periods for both nodes, each Pico-Net can enable transmissions between devices that cannot “hear” each other. For example, referring to FIG. 1, Node 2 and 8 are not interfering and can therefore share the same CTO time slot.

FIG. 5,6 indicates a configuration where the two PNC nodes, Nodes 4 and Nodes 5 do not interfere and therefore can share the same time periods. Note that both Nodes 4 and 5 care in the “receiving list” for Node 1. The algorithm for Beacon synchronization takes that into account the dependencies and provides the optimal setting where only those nodes that may create interference are offset.

FIG. 7,8 indicates a more complex configuration with four PNC nodes. Nodes 4 and Nodes 5 do not interfere and therefore can share the same time periods. Note that both Nodes 4 and 5 care in the “receiving list” for Node 1. Additionally Node 7 is staggered to avoid interference with Nodes 1, 4, 5. The algorithm for Beacon synchronization takes into account the dependencies and provides the optimal setting where only those nodes that may create interference are offset.

FIG. 9 depicts the decision flow graph to address the situation where in the current implementation of the 802.15 MAC, two or more PNC nodes are sending beacons and are unaware that their beacons are interfering. This decision flow graph addresses this issue.

FIG. 10 shows how the beacon position is periodically changed by inserting an irregular width frame into a succession of equal width frame packets, with the intent of detecting a beacon that may be transmitting at the same instant as another PNC.

FIG. 11 depicts one approach to selecting the “head” PNC in the situation where a number of PNCs have devices in common and have to align their Beacons so that the transmissions between the PNCs and their devices do not interfere. To do so requires the selection of a “Head” PNC, based on some selection criteria and a tie breaking arrangement.

FIG. 12 depicts an alternate approach to selecting “head” PNCs. using an extensible beacon slot reservation scheme.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

Beacon Synchronization

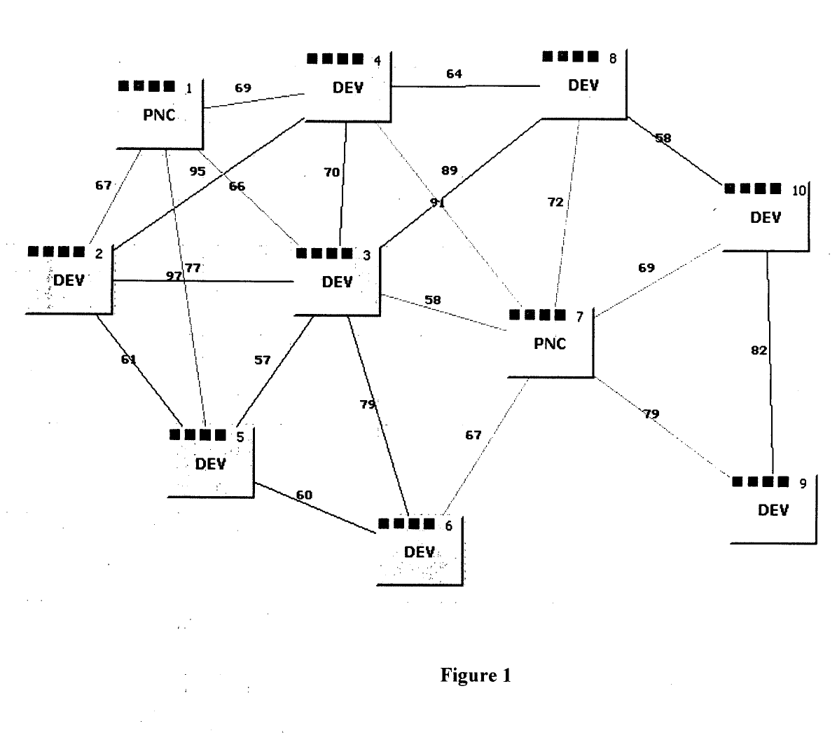

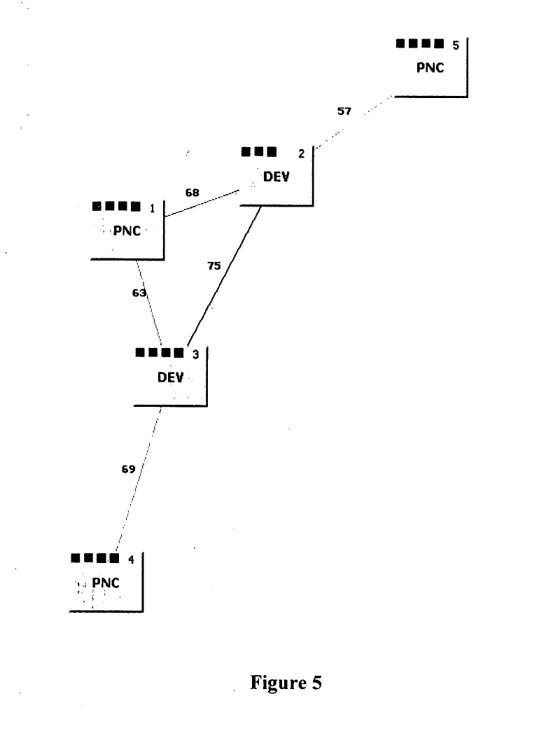

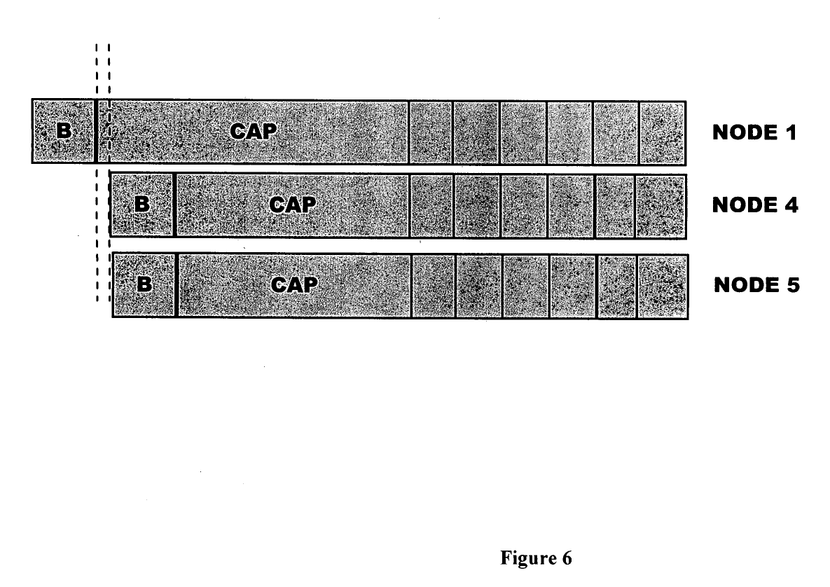

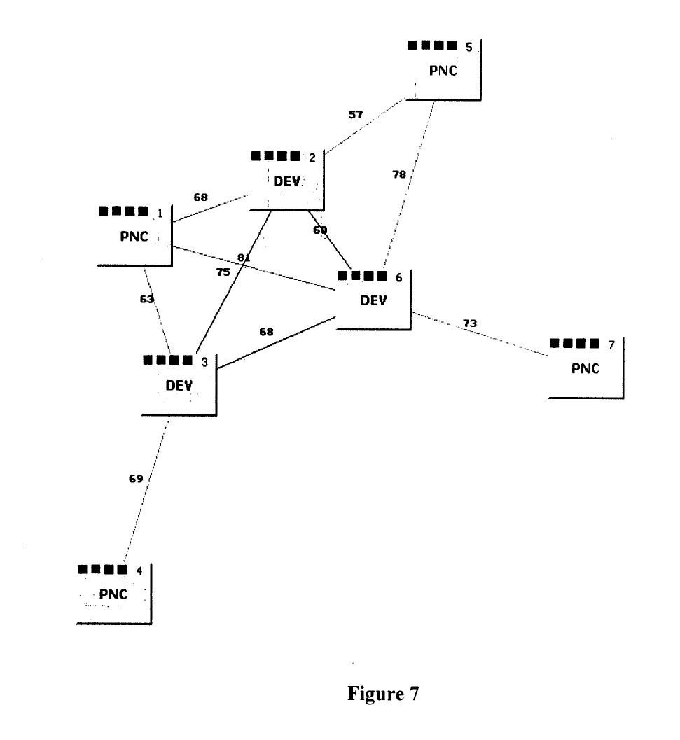

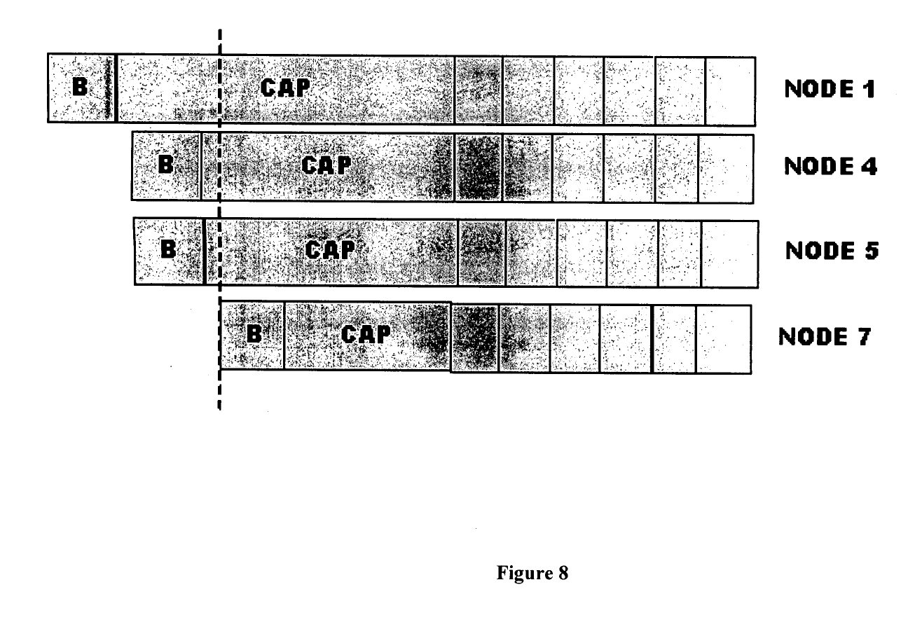

In wireless networks, channel disturbance is not a problem at the transmitting end, but at the receiving end. Referring to FIG. 1, Node 2 and Node 7 do not hear each other, but still cannot transmit simultaneously because Node 3 is in hearing distance from both of them. Conversely, Nodes 9 and 2 can transmit simultaneously as they do not have any common node in their “reachable” list of neighbors. Therefore one approach to determining which beacons can be transmitted simultaneously is to determine if there is a NULL set of common reachable nodes. For example, referring to FIG. 5, Nodes 4 and 5 have no common nodes in their reachable list. Hence they can transmit at the same time as shown in FIG. 6.

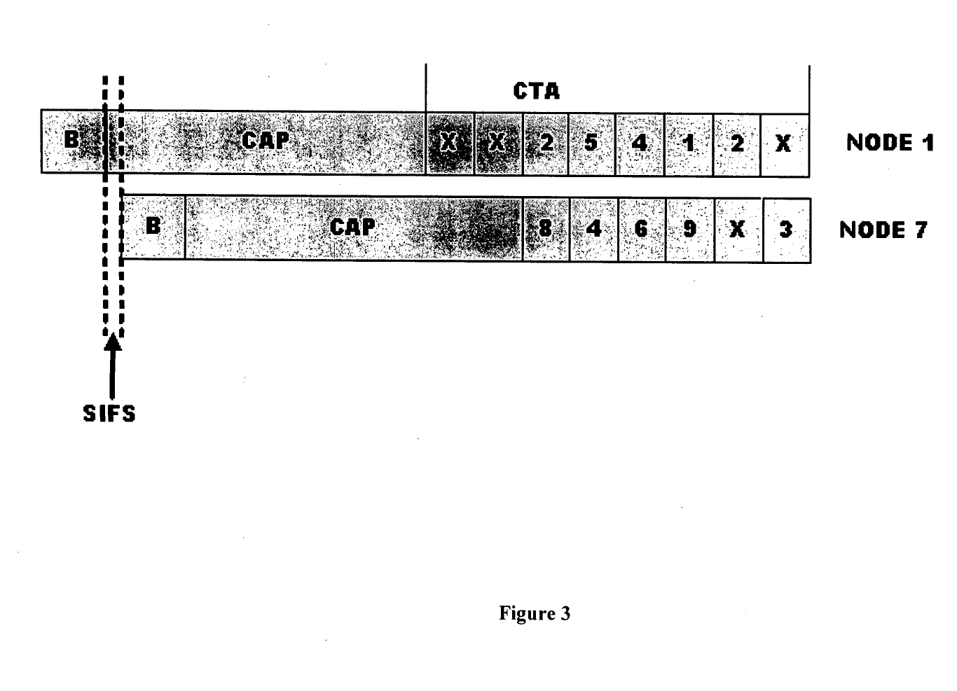

When PNC Nodes do have nodes in common in their reachable list then simultaneous transmission is not permissible. Under those circumstances one beacon transmission must be staggered as shown in FIG. 3. As shown in FIG. 3, Node 7 sends its beacon a short time (SIFS) after the beacon from Node 1 has concluded.

Compliant with 802.15.3 terminology, SIFS stands for Short Inter Frame Spacing which is kept lower than BIFS, (Back off Inter Frame Spacing), the normal delay before the contention access period begins. This therefore ensures that the Beacon is transmitted before any device in the Pico-Net is granted access to the Contention Access Period (CAP). As long as the Beacon duration+SIFS+Air transmission time is less than BIFS, this approach works. In the case of 802.15.3 networks, with a range of less than 10 meters, air transmission time is sufficiently low to allow SIFS delayed Beacon transmissions.

CAP & CTA Alignment Overview

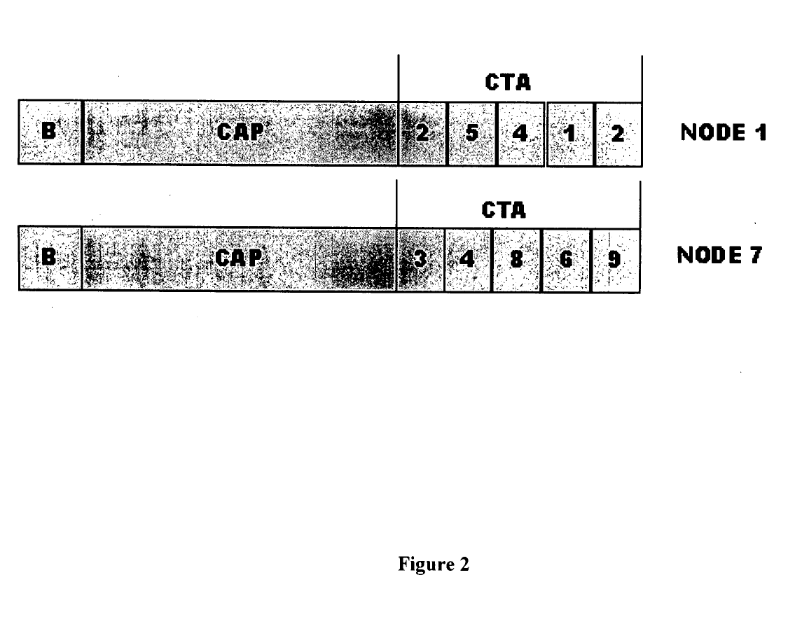

After staggering the beacon transmissions, CAP and CTA periods of Pico-Nets need to be aligned to avoid interference. Referring to FIG. 2, Node 1 and Node 7 are in interference regarding beacon synchronization. FIG. 3 shows Node 7 Beacon offset from the end of transmission edge of the Beacon for Node 1. One embodiment of this invention is to determine how and when those offsets need to be implemented to ensure a stable and scalable approach to simultaneous operating Pico-Nets.

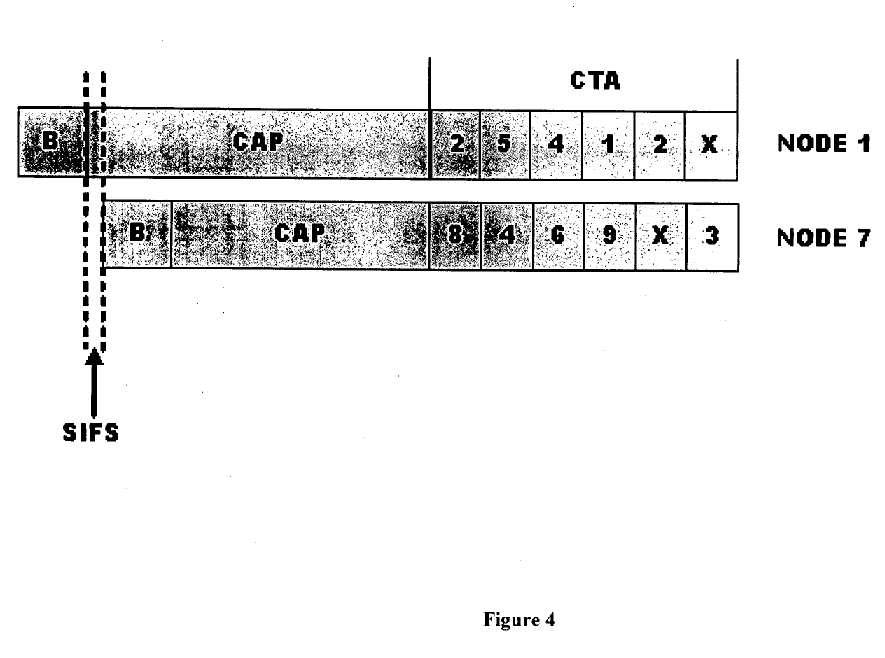

Referring to FIG. 2 the super-frames for Node 1 and Node 7 are shown, where the super-frames is the container of the CAP and CTA allocations described earlier and shown in FIG. 2. FIGS. 3 and 4 show two strategies for CAP alignment. Both strategies make the secondary PNC (node 7) begin its super-frame SIFS time units after the completion of the primary PNC's beacon. The SIFS wait ensures that Node 7 will get access to the medium before other devices as they would normally wait for BIFS time units.

In FIG. 3, the CAP duration for Node 7 remains unchanged, hence Node 1 needed to mark its first two CTA slots as private. After the completion of Node 7's CAP, both Node 1 and Node 7 begin their CTAs which have been re-assigned as shown in FIG. 3.

In FIG. 4, the CAP duration for Node 7 is reduced so that its CAP end is aligned with Node 1's CAP end, after which both nodes begin their CTAs which have been re-assigned in a similar manner. By the same token, Node 1 could have also increased its CAP duration so that its end is aligned with Node 7's CAP end. In this case Node 1 does not need to mark its first two CTA slots as private.

CAP Alignment Slider

The two methods for CAP alignment discussed above and depicted in FIG. 3 and FIG. 4, are two extremes of CAP alignment strategy line. A parameter may be supplied to the algorithm so that results at any point between the two extremes may be derived. For example, the CAP may be reduced by a certain value and a few CTA slots may also be marked as shown in FIG. 3. The number of slots reserved and the value by which the CAP is reduced would be driven by this parameter. Thus, different embodiments of this invention, with a CAP Alignment slider can support multiple alignment strategies based on differing needs for CAP or CTA period durations.

For example, if the CAP period is not being used or there are many devices requiring the CTA allocations, the alignment slider would favor reducing the CAP period (FIG. 4) over overlapping CAP and CTA (FIG. 3) which results in two slots in Node 1 becoming un-usable. Conversely, if the applications require more CAP than CTA, the slider would drive the algorithms towards FIG. 3 as opposed to FIG. 4.

Optimal Staggering of PNC Beacons

In FIG. 5, since PNC Nodes 4 and PNC Nodes 5 do not have any node in common, they both start their beacons at the same time. Assuming Node 5 has a higher PNC Tic Count, FIG. 8 shows the CAP alignment by using algorithms described in this document. Note that the algorithms discover the best settings to minimize the amount of CAP period reduction needed when interfering PNC nodes are added to the system.

Comparison with Other Approaches

Another approach to Beacon Synchronization considered was to allocate one private CTA for the beacon and CAP and aligning CTAs in a way that causes no interference. Allocating a private CTA for the beacon and CAP ensures that the beacon and the CAP that follows are totally non-interfering. But this method can also be wasteful, as there could have been devices that could have been transmitting without interference. Additionally, with each additional Pico-net there is a corresponding reduction of the CTA.

Consider the case where there are three Pico-Nets in the same vicinity. There will therefore be two sets of super-frames (CTA and CAP) supported inside the CTA period of the first PNC. This results in an progressive deterioration of bandwidth since with each additional Pico-Net addition, there is a corresponding reduction in the CTA for the first PNC and both CTA and CAP reductions for all other PNCs. This brute force approach is neither scalable, nor efficient.

Support Functions Needed by Algorithms

Support functions needed by the algorithms computing the beacon offsets include:

1. Function CanHear(a).
Input: Node a
Returns: Set of nodes that Node a can hear

2. Function Simul(a, b),
Input: Node a, Node b
Returns: true if Nodes a, b can transmit simultaneously, false otherwise. Example Simul(a, b)=((CanHear(a)∩CanHear(b))=Ø)

3. Function BeaconEndTime(a),
Input: Node a
Returns: Packet duration of Node a's beacon.

4. Function PNCTickCount(a)
Input: Node a
Returns: The time tick count since Node a became PNC.

5. Function SimulSet(a, S)
Input: Node a, Set of nodes S
Returns: Set Ss={c; Simul(c, a)=false for all cεS}

6. Function CTASlotList(a)
Input: Node a
Returns: List of all nodes who have been allotted CTA slots by PNC node a. If a node has been allotted more than one CTA slot, it would have two distinct entries in the list.
   CAP Alignment Algorithm

Let P be the primary PNC, and {S0, S1, . . . , Sn} be the secondary PNC's which need to align their CAP with P. PNCTickCount(Si)>PNCTickCount(Si+1) for all i.

S0 aligns its beacon with P such that
1—Beacon time of S0=BeaconEndTime (P)+SIFS and
2—CAP duration of S0=CAP duration of P−BeaconEndTime (P)−SIFS.

Consider Sk (0<K<n) such that we have already aligned the beacons of {S0, . . . , SK−1}. Now we need to align the beacon of Sk.

Let SSK=SimulSet(Sk, {S0, . . . , SK−1}).

If SSK=Ø then beacon time of Sk=beacon time of S0, CAP duration of Sk=CAP duration of S0.

Otherwise let SSK={SJ}, 0<=J<=N(SSK) and PNCTickCount(Sj)>PNCTickCount(Sj+1).

Then beacon time of Sk=BeaconEndTime (SM)+SIFS, and CAP duration of Sk=CAP duration of SM−BeaconEndTime (SM)−SIFS, where M=N(SSK).

CTA Re-Assignment Algorithm

Let P be the primary PNC, and {S₀,S₁, . . . Sₙ} be the n secondary PNC's which need to align their CTA slots with the CTA slots of P. Arrange the Pico-Net order such that PNCTickCount(Sᵢ)>PNCTickCount(Sᵢ₊₁) for all i.

Consider the following set definitions:

A = {Aᵢ} = {CTASlotList (P),
CTASlotList (S₀) ,..., CTASlotList (Sₙ)}.
B = {Bᵢ] where
Bᵢ =NUMBER_OF_ITEMS_IN_SET (Aᵢ)
Let E <= new Array [n+1]
For I = 0 to n

E[i] = ø ; where ø = NULLSET

Next I
For I = 0 to MAX (B)−1

For J = 0 to n

If AJ <> ø then

D = ø
For K = 0 to J−1

D = D SETUNION CanHear (E[K,I])
D = D SETUNION E[K,I]

Next K
T = AJ SETDIFFERENCE D
If T <> ø then

E[J] = E[J] SETUNION T[0]
AJ = AJ SETDIFFERENCE T[0]

Else

E[J] = E[J] SETUNION X

End If

Else

E[J] = E[J] SETUNION X

End If

Next J

Next I

Simultaneous Beacon Transmissions

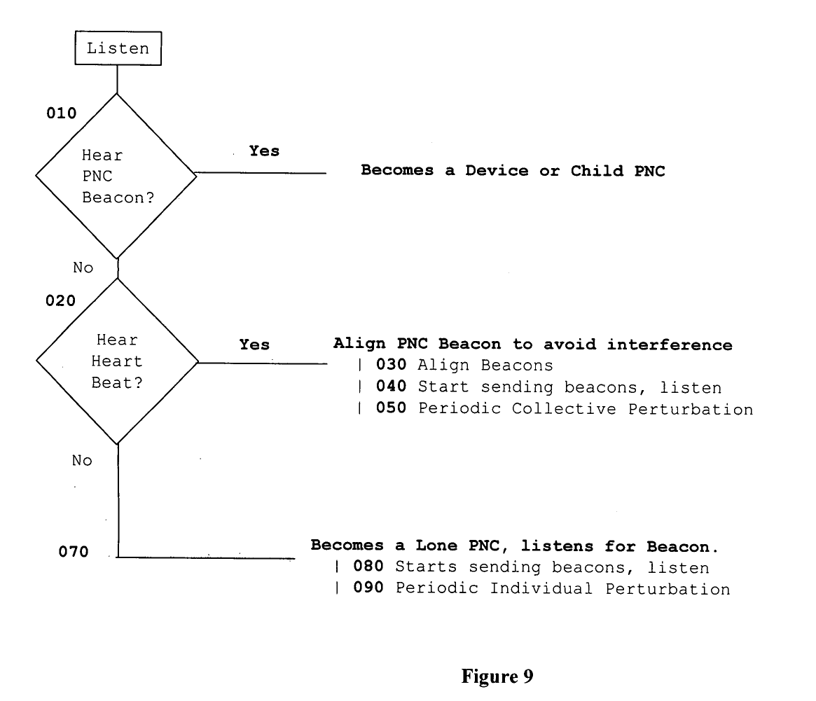

The algorithms described relate to aligning the beacon of a PNC to avoid interference with another beacon from another PNC. This implies that the timing of the beacon is, in some manner communicated to the PNC intending to perform an alignment. This is achieved by either hearing the Beacon directly or hearing a heart beat. These two situations are shown in FIG. 9 labeled 010 and 020 respectively. The reason for Periodic Collective Perturbation, labeled 050 in FIG. 9, will be addressed shortly.

If there is no beacon heard, one cannot assume that the PNC is alone—the beacon may be being sent by another PNC at precisely the same time that this PNC is sending its beacon. The “listen” period for a PNC is primarily in the Contention Access Period (CAP)—Beacons occurring in either the CTA or the beacon period are thus not easily detected.

Assume that a beacon is being sent by another PNC at the exact same time as this PNC's beacon transmission or in one of the CTA time slots. It will never be detected as long as both PNCs continue to follow the same pattern of transmissions with the beacon sent at the same time and super-frame sizes identical. By implication, devices within ear shot of both beacons will behave in an unacceptable erratic fashion.

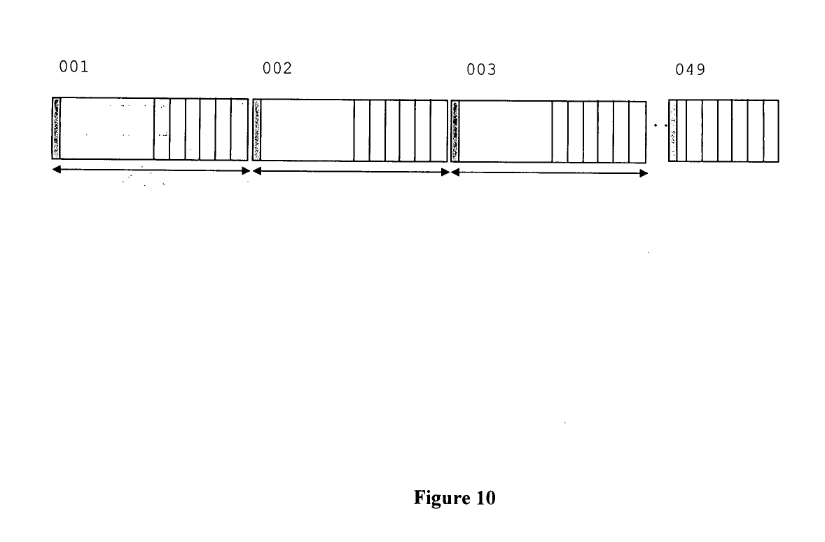

To ensure that the beacon will be eventually heard by a PNC, a random perturbation is introduced, labeled 090 and shown in FIG. 10. Once every few frames, an “abnormal” frame is sent—which is made smaller or larger by changing the width of the CAP period. This in turn would cause the beacon alignment hypothesized to become detectable. Note that all PNCs would be performing this random perturbation—thereby eventually breaking any accidental synchronicity.

By the same logic, a group of PNCs that are aligned (case 050) must also follow some random perturbation. However, since the PNC's are aligned, the heart beat is needed to communicate with the PNCs regarding when to align themselves to a proposed beacon timing change.

Selection of the “Head” PNC

To ensure that the PNCs agree to align themselves as before, one PNC is selected to be the “head” of the family. Selection criteria for selection of the “head” could be the number of children or seniority. Based on a set of selection criteria, the “head” PNC periodically changes his beacon position by changing the CAP period based on a random number generation. All other PNCs in the family take their cue from the “head” and align to the changed Beacon timing of the “head” PNC.

Selection of the “Head” PNC is based on criteria such as seniority and number of children. In the event that the selection criteria for the “Head” used (e.g. number of children or seniority) results in a tie, then a random number created by each PNC is used to break the tie between the two or more contenders. Note that under Appendix A, the field TB or Tie Breaker is reserved for the random number value.

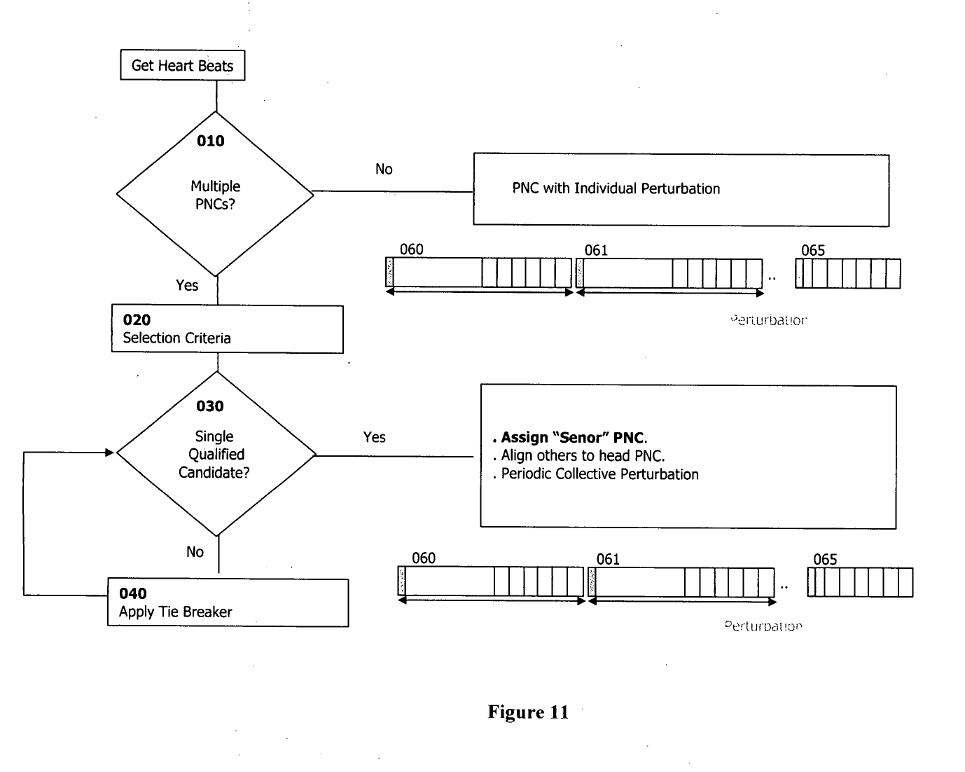

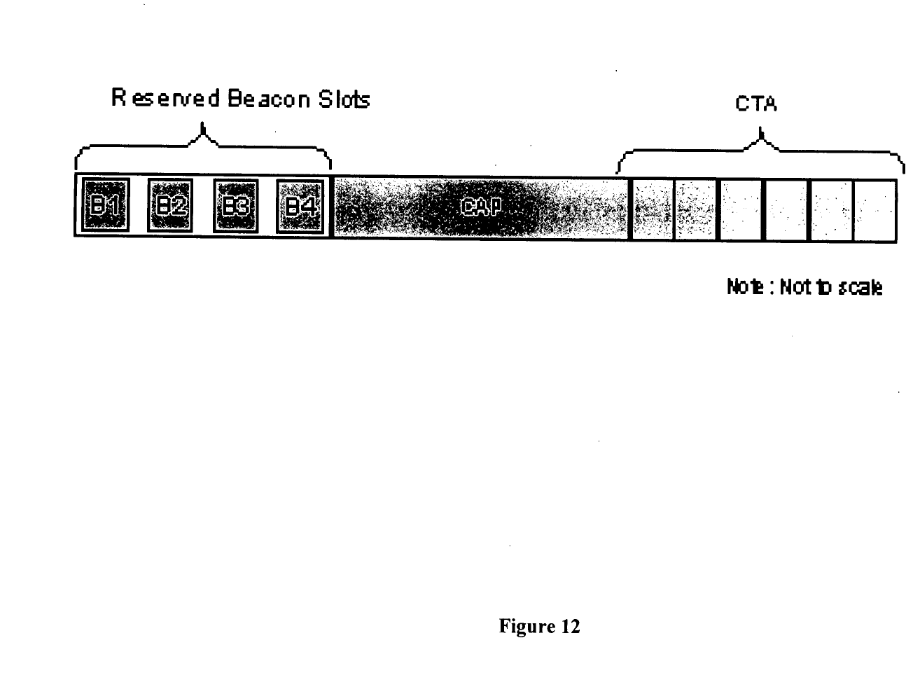

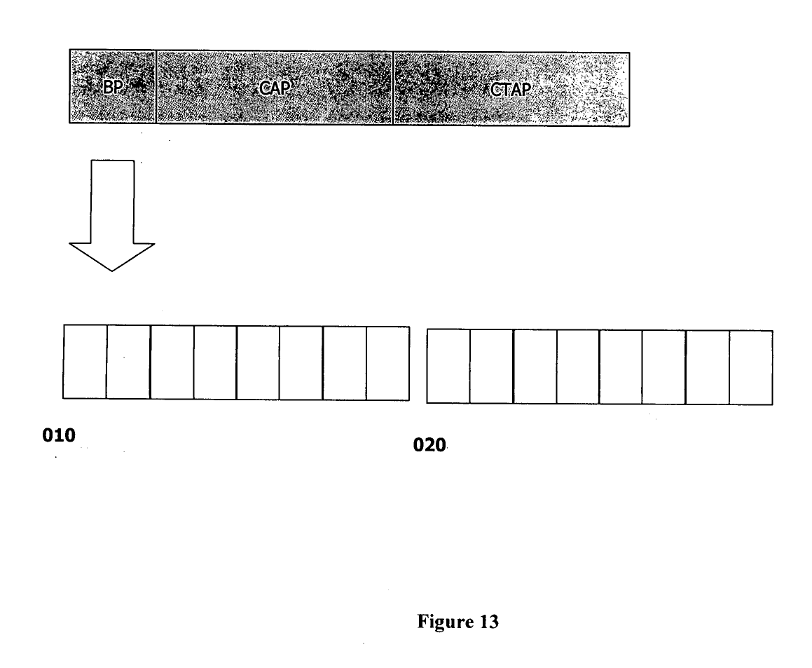

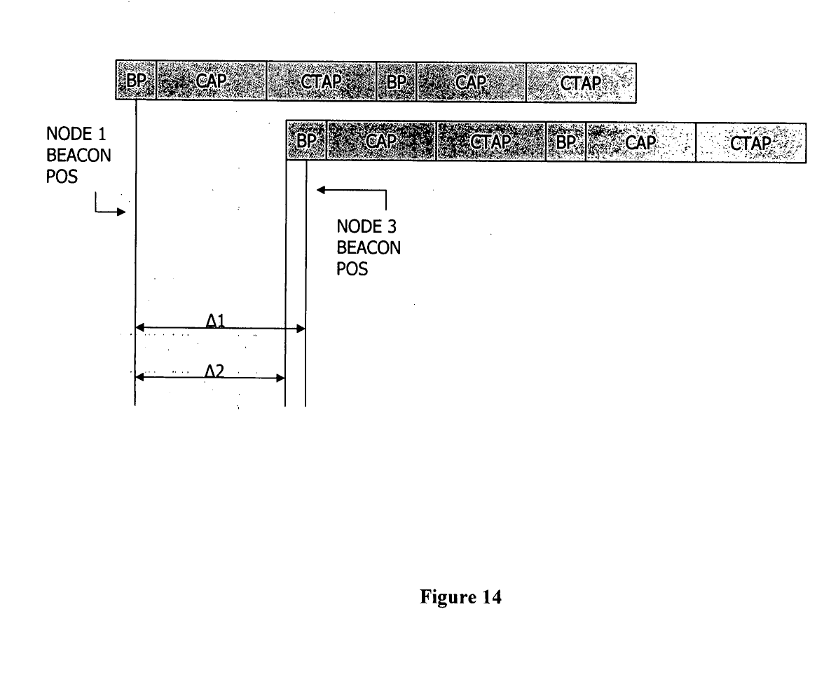

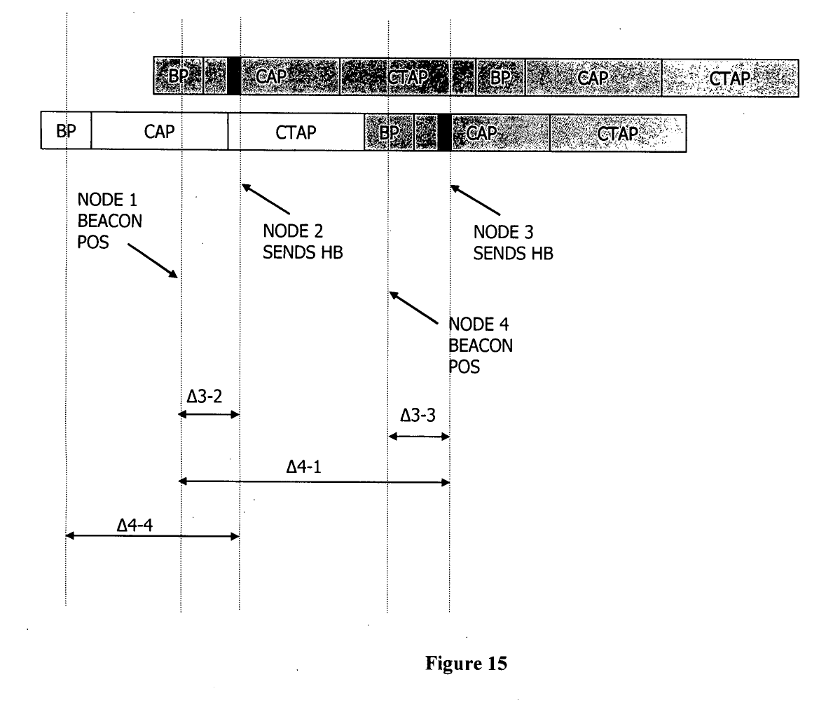

Information on the selection parameter—including a random number generated by each PNC to be used in case there is a tie between two PNCs—must be transmitted to all the PNCs in the vicinity, to establish the correct pecking order. Having done so, each PNC must now be aligned based on the requirements set by the Head PNC. The flow logic diagram in FIG. 11, depicts the steps described.

Based on the information transmitted in the heart beat, devices inform each other of the existence of PNCs in the vicinity and their beacon information. If the PNCs are aligned (because they may share devices in common) then information about them needs to be passed on to the “Head” PNC that will manage the alignment of all PNCs in the extended Pico-Net.

This is a complex process, requiring coordination between PNCs based on heart beart information received from devices (Bear in mind we are examining the case where the PNCs cannot hear each other else the alignment process is more direct. To ensure no confusion over the air waves, a strict protocol must be followed, as described in the Appendix A and Appendix B.

Applicability to Other Types of Networks.

The terminology used in this patent application refers to the wireless 802.15.X Medium Access Control (MAC) and definitions related to that implementation of the MAC. However, the concepts outlined and algorithms are applicable to a wide variety of networks.

Specifically, such as 802.16 have MAC specifications similar to the 802.15.3/4 MAC. As such our approach would be relevant to simultaneous operating sub networks requiring some coordination of the time allocation periods using a beacon for synchronizing transmissions between the devices.

Therefore, methods and software for implementing a wireless network with simultaneously operating pico-nets, has been described.

It should be understood that the particular embodiments described above are only illustrative of the principles of the present invention, and various modifications could be made by those skilled in the art without departing from the scope and spirit of the invention. Thus, the scope of the present invention is limited only by the claims that follow.

Appendix A

The data format described below is an extension to our heart beat approach described in U.S. patent application Ser. No. 10/434,948, filed May 8, 2003 and incorporated by reference. The packet format described below is an extension to that protocol. It is described here to indicate how beacon data transmitted in the heart beat and used to align the beacons.

Based on the information transmitted in the heart beat, devices inform each other of the existence of PNCs in the vicinity and their beacon information. If the PNCs are aligned (because they may share devices in common) then information about them needs to be passed on to the “Head” PNC that will manage the alignment of all PNCs in the extended Pico-Net.

Selection of the “Head” PNC is based on criteria such as seniority and number of children—however that information—and a random number generated by each PNC to be used as a tie-breaker—must also be transmitted to all the PNCs in the vicinity, to establish the correct pecking order. Have done so, each PNC must now be aligned based on the requirements set by the Head PNC. This is a complex process and to ensure no confusion over the air waves, a strict protocol based handshaking must be followed, as described in APPENDIX B. This appendix covers the handshaking protocol and data format in Table A2.

[image]

[image]

[image]

[image]

[image]

[image]

[image]

[image]

[image]

[image]

[image]

[image]

1. A dynamic wireless network comprising:
multiple wireless sub networks operating within the range of each other, wherein each of said wireless sub networks is managed by a PNC, and wherein the transmissions of information within said sub network are synchronized by a beacon transmission from said PNC, and wherein PNCs adjust the timing of their beacon transmissions so as not to interfere with other PNC beacon transmissions.

2. The dynamic wireless network as in claim 1 wherein a systematic flow of information is transmitted on both a periodic and on an exception basis through the network using the devices in the network (both PNC and client devices) to convey information of one part of the wireless network to another as in a relay fashion.

3. The dynamic wireless network as in claim 2 where the information flow from client devices in a sub network is transmitted to the PNC managing those devices, so that the particular PNC is made aware of other PNCs in the range of devices in the particular PNC's sub network.

4. The dynamic wireless network as in claim 3 where multiple PNCs coordinate their beacon transmissions to align their CAP and CTA periods.
